(19) United States
(12) Patent Application Publication
(10) Pub. No.: US 2011/0265999 A1
(43) Pub. Date: Nov. 3, 2011

(54) REVERSE TORQUE DRIVE SYSTEM

(75) Inventors: Bill Cayford, Lloydminster (CA); Diane Cayford, Lloydminster (CA)

(73) Assignee: AMIK OILFIELD EQUIPMENT & RENTALS LTD., Lloydminster (CA)

(21) Appl. No.: 12/772,022

(22) Filed: Apr. 30, 2010

(51) Int. Cl. E21B 37/00; F16D 39/00

(52) U.S. Cl. 166/311; 60/493; 166/53

(57) ABSTRACT

A reverse torque drive system for a wellhead has a hydraulic pump having an inlet and an outlet, and a hydraulic motor having a first port and a second port. There is a valve body having a first position that connects the outlet of the hydraulic motor to the first port and the second port to the inlet, and a second position that connects the outlet to the second port and the first port to the inlet. One or more sensors are connected to measure a condition, and a controller moves the valve body from the first position to the second position upon the sensor sensing a predetermined condition.

### FIELD

This relates to a reverse torque drive system used to drive a rotary downhole pump for a hydrocarbon producing well.

### BACKGROUND

Hydraulic systems are commonly used on wellsites to drive downhole pumps to produce hydrocarbons from a well. When a well becomes sanded in a flushing operation is sometimes used to restore or improve production.

### SUMMARY

There is provided a reverse torque drive system for a wellhead comprising a hydraulic pump having an inlet and an outlet, and a hydraulic motor having a first port and a second port. There is a valve body having a first position that connects the outlet of the hydraulic motor to the first port and the second port to the inlet, and a second position that connects the outlet to the second port and the first port to the inlet. One or more sensors are connected to measure a condition, and a controller moves the valve body from the first position to the second position upon the sensor sensing a predetermined condition.

According to another aspect, the sensor may be a flow meter connected to a production outlet of the wellhead, and the predetermined condition may be a predetermined flow rate. Alternatively, the sensor may be a torque sensor connected to the hydraulic pump, and the predetermined condition may be a predetermined torque applied by the hydraulic pump.

According to another aspect, there may be an auxiliary hydraulic motor that is driven by the hydraulic pump and that drives an auxiliary pump connected to a production line of the wellhead. The auxiliary hydraulic motor is activated when the valve is in the second position to push production fluid downhole.

According to another aspect, there may be provided, in combination, a wellhead, a rotary downhole pump disposed below the wellhead, a production tank that receives fluid pumped by the rotary downhole pump, and a reverse torque drive system as described above.

According to another aspect, there is provided a method of flushing a well being pumped by a rotary pump. The method comprises the steps of providing a reverse torque drive system as described above; moving the valve body from the first position to the second position once a predetermined condition is reached; and flushing the well by driving the hydraulic motor in a reverse direction.

According to another aspect, the predetermined condition may be a flow rate from a production outlet of the wellhead, or a torque applied by the hydraulic pump.

According to another aspect, the method may further comprise the step of causing the hydraulic pump to drive an auxiliary hydraulic motor that drives an auxiliary pump connected to a production line of the wellhead, wherein the auxiliary hydraulic motor is activated when the valve is in the second position to push production fluid downhole.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a reverse torque drive system at a wellsite.

FIG. 2 is a schematic view of a reverse torque drive system.

### DETAILED DESCRIPTION

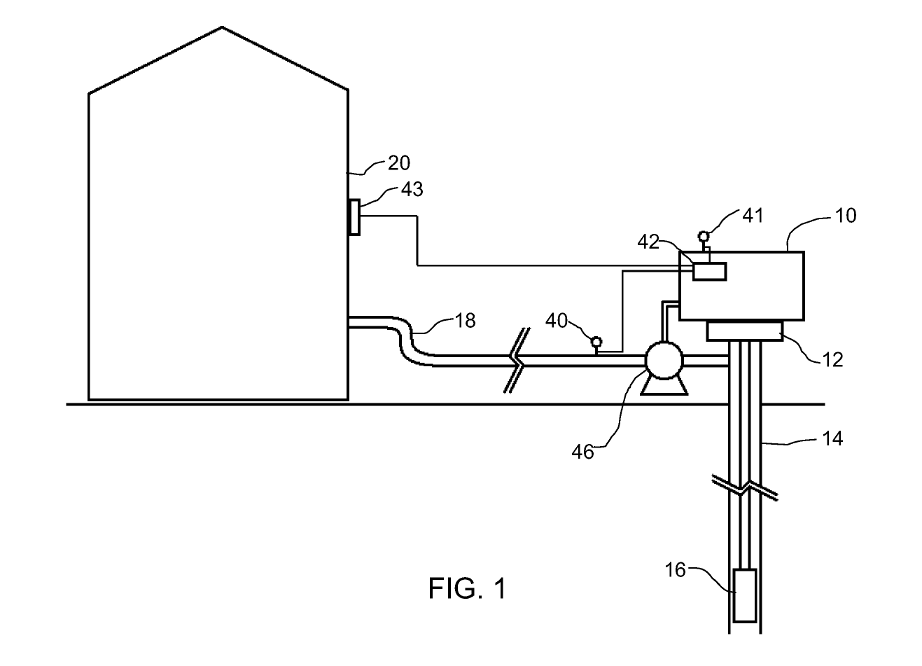

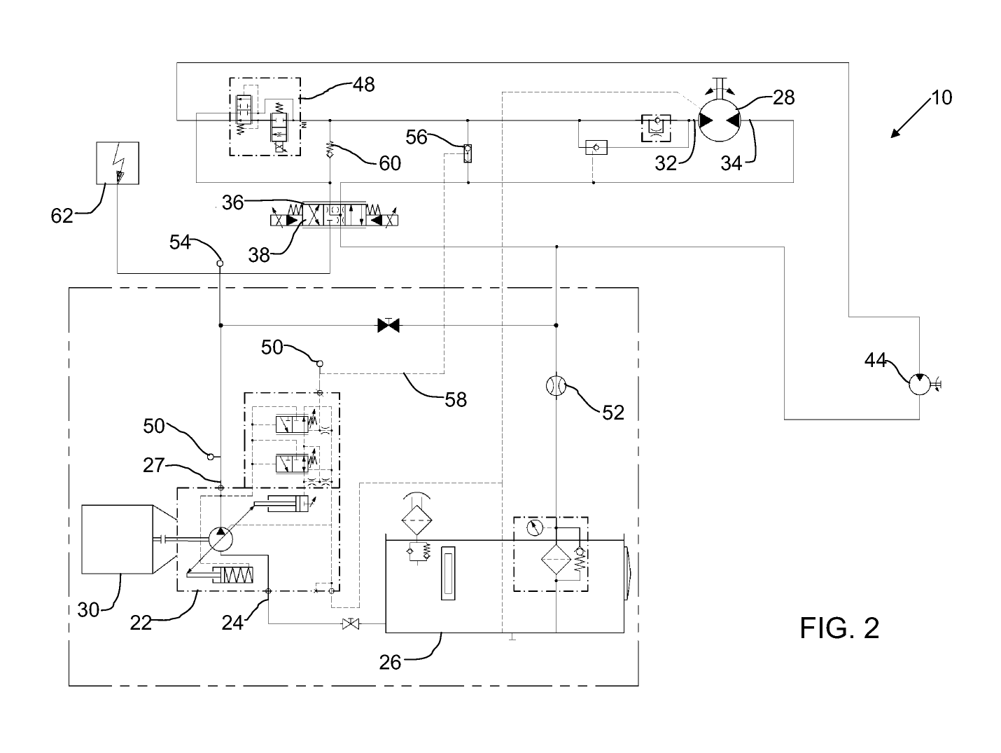

A reverse torque drive system generally identified by reference numeral 10, will now be described with reference to FIGS. 1 and 2.

### Structure and Relationship of Parts

Referring to FIG. 1, reverse torque drive system 10 is designed to be used in connection with a wellhead 12 above a wellbore 14 that has a rotary downhole pump 16, such as a progressive cavity pump, as are known in the art. A production line 18 carries produced fluid from wellhead 12 to a production tank 20. Drive system 10 is used to drive rotary downhole pump 16. Under certain circumstances, it is advantageous to flush wellbore 14 to restore or improve production. For example, when production flow reduces to a certain rate, or to a certain percentage of the average or expected production flow, this may be an 40 indication that the perforations in the wellbore or that the formation is becoming plugged with sand. Another example is when the torque required to drive rotary pump 16 reaches a certain point, either an absolute point or a point relative to the average or expected torque, which may indicate that rotary pump 16 is drawing more sand, and may become plugged. In each of these circumstances, wellbore 14 may be flushed as described below to improve the flow of production fluids from wellbore 14.

Referring to FIG. 2, reverse torque drive system 10 has a hydraulic pump 22 having an inlet 24 connected to a hydraulic fluid reservoir 26 and an outlet 27 connected to a hydraulic motor 28. Hydraulic pump 22 is driven by a power source 30, such as an internal combustion engine capable of supplying the desired horsepower. Hydraulic motor 28 is designed to be driven in either direction, and has a first port 32 and a second port 34. A valve body 36 connects hydraulic pump 22 to hydraulic motor 28. In a first position, i.e. with actuator 38 moved to the left, valve body 36 connects outlet 27 of hydraulic motor 28 to first port 32 and second port 34 to inlet 24 such that hydraulic motor 28 rotates to draw fluid out of wellbore 14 into production tank 20. In a second position, i.e. with actuator 38 moved to the right, valve body 36 connects inlet 24 of hydraulic motor 28 to first port 32 of pump 22 and second port 34 to outlet 27 such that fluid is pumped from production tank 20 downhole into wellbore 14.

Referring to FIG. 1, one or more sensors are provided to measure the desired condition that will cause hydraulic motor 28 to reverse direction. As shown, there are two sensors 40 and 41. Sensor 40 is a flow sensor on production line 18, and sensor 41 is a toque sensor on drive system 10. Data from sensors 40 and 41 may be fed into a controller 42, which moves valve body 36 from the first position to the second position once a predetermined condition is reached. Controller 42 may be a processor that is connected to valve body 36, and, referring to FIG. 2, actuator 38 may be a solenoid that is actuated by controller 42. Alternatively, sensors 40 and 41 may act as the controller. Actuator 38 will be held in second position until the desired amount of time has passed, or volume of fluid is moved. This may be determined by different known methods. As shown, it may be determined using flow sensor 40, or a tank level indicator 43 on production tank 20. Generally speaking, in a flushing operation, it is preferred to flush wellbore 14 with about twice the fluid capacity of wellbore 14. For example, if wellbore 14 has a fluid capacity of 2 cubic meters, then 4 cubic meters will be flushed downhole. As shown, the fluid pumped downhole is from production tank 20, such that a second fluid source is not required.

In some circumstances, referring to FIG. 2, an auxiliary hydraulic motor 44 that drives an auxiliary hydraulic pump 46 on fluid line 18 shown in FIG. 1 may be used to increase the rate at which fluid is pumped downhole to reduce the downtime of wellbore 14. Auxiliary motor 44 is activated when valve body 36 is in second position. Referring to FIG. 2, this may be done by providing a second valve body 48, such as a solenoid valve, that is actuated simultaneously with valve body 36.

Referring to FIG. 2, reverse torque drive system 10 has other components that enhance its operability. As shown, pressure gauges 50, flow meter 52, and pressure transducer 54 may be provided to help monitor system 10. In addition, a shuttle valve 56 connected to a sensing line that runs to hydraulic pump 22 may be used to provide feedback on the fluid pressure provided to hydraulic motor 28. A check valve 60 is also provided between hydraulic pump 22 and hydraulic motor 28. Other valves and components as indicated may be provided as will be recognized by those skilled in the art. Furthermore, it will also be recognized that hydraulic pump 22 may be used to provide hydraulic power to other components, such as a stuffing box, which may be connected to the pressure reducing valve 62.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A reverse torque drive system for a wellhead, comprising:
a hydraulic pump having an inlet and an outlet;
a hydraulic motor having a first port and a second port;
a valve body having a first position that connects the outlet of the hydraulic motor to the first port and the second port to the inlet, and a second position that connects the outlet to the second port and the first port to the inlet;
one or more sensors connected to measure a condition; and
a controller for moving the valve body from the first position to the second position upon the sensor sensing a predetermined condition.

2. The reverse torque drive body of claim 1, wherein the sensor is a flow meter connected to a production outlet of the wellhead, and wherein the predetermined condition is a predetermined flow rate.

3. The reverse torque drive system of claim 1, wherein the sensor is a torque sensor connected to the hydraulic pump, and wherein the predetermined condition is a predetermined torque applied by the hydraulic pump.

4. The reverse torque drive system of claim 1, further comprising an auxiliary hydraulic motor that is driven by the hydraulic pump and that drives an auxiliary pump connected to a production line of the wellhead, wherein the auxiliary hydraulic motor is activated when the valve is in the second position to push production fluid downhole.

5. A method of flushing a well being pumped by a rotary pump, the method comprising the steps of:
providing:
a hydraulic pump having an inlet and an outlet; and
a hydraulic motor having a first port and a second port, the hydraulic motor driving the downhole rotary pump; and
a valve body having a first position that connects the outlet of the hydraulic motor to the first port and the second port to the inlet, and a second position that connects the outlet to the second port and the first port to the inlet;
moving the valve body from the first position to the second position once a predetermined condition is reached; and
flushing the well by driving the hydraulic motor in a reverse direction.

6. The method of claim 5, wherein the predetermined condition is a flow rate from a production outlet of the wellhead.

7. The method of claim 5, wherein the predetermined condition is a torque applied by the hydraulic pump.

8. The method of claim 5, further comprising the step of causing the hydraulic pump to drive an auxiliary hydraulic motor that drives an auxiliary pump connected to a production line of the wellhead, wherein the auxiliary hydraulic motor is activated when the valve is in the second position to push production fluid downhole.

9. In combination:
a wellhead;
a rotary downhole pump disposed below the wellhead;
a production tank that receives fluid pumped by the rotary downhole pump a reverse torque drive system, comprising:
a hydraulic pump having an inlet and an outlet;
a hydraulic motor having a first port and a second port;
a valve body having a first position that connects the outlet of the hydraulic motor to the first port and the second port to the inlet, and a second position that connects the outlet to the second port and the first port to the inlet;
one or more sensors connected to measure a condition; and
a controller for moving the valve body from the first position to the second position upon the sensor sensing a predetermined condition.

10. The reverse torque drive body of claim 9, wherein the sensor is a flow meter connected to a production outlet of the wellhead, and wherein the predetermined condition is a predetermined flow rate.

11. The reverse torque drive system of claim 9, wherein the sensor is a torque sensor connected to the hydraulic pump, and wherein the predetermined condition is a predetermined torque applied by the hydraulic pump.

12. The reverse torque drive system of claim 9, further comprising an auxiliary hydraulic motor that is driven by the hydraulic pump and that drives an auxiliary pump connected to a production line of the wellhead, wherein the auxiliary hydraulic motor is activated when the valve is in the second position to push production fluid downhole.
